(19) United States
(12) Patent Application Publication
(10) Pub. No.: US 2022/0337088 A1
(43) Pub. Date: Oct. 20, 2022

(54) HIGHWAY INTEGRATED SOLENOID CHARGING SYSTEM

(71) Applicant: Vandette B. CARTER, Yorktown Heights, NY (US)

(72) Inventor: Vandette B. CARTER, Yorktown Heights, NY (US)

(21) Appl. No.: 17/535,979

(22) Filed: Nov. 26, 2021

Related U.S. Application Data
(60) Provisional application No. 63/118,738, filed on Nov. 26, 2020.

(51) Int. Cl. H02J 50/10; H02J 50/00; H02J 50/80

(52) U.S. Cl. CPC H02J 50/10; H02J 50/005; H02J 50/80

(57) ABSTRACT

A vehicle recharging system using as least one electromagnet situated in a subterranean manner, to act upon another solenoid situated within a vehicle, to generate electricity by induction for that vehicle, while it is in motion or at rest. In another embodiment the subterranean solenoid magnetic flux is made to rotate a series of circumferentially arranged magnets, so as to actuate a generator connected thereto by a shaft.

This application is claims the benefit of and priority from U.S. provisional patent application Ser. No. 63/118,738, filed on Nov. 26, 2020.

### FIELD OF THE DISCLOSURE

The technology is in the field of wireless electric or hybrid vehicle charging system, which does not require a physical charging port connection.

### BACKGROUND ART

Wireless charging for electric vehicles are for the most part being pursued around ‘magnetic resonant coupling’—a technology invented by Nikola Tesla more than a century ago. More specifically, the charging technology for vehicles either relies on tightly-coupled inductive or loosely-coupled resonant to achieve said goal. Examples of tightly-couple inductive charging are seen in: https://www.energy.gov/eere/videos/wireless-charging-electric-vehicles Also similar technology can be appreciated in U.S. Pat. No. 8,975,864 (H. Kim).

Qualcomm® and Witricity® have several patents (U.S. Pat. Nos. 8,084,889; 8,076,800; 8,395,282; 8,395,283; 8,400,018 and 8,760,007 to list a few) utilizing resonance to wirelessly charge a vehicle that is stationary, thereby allowing vehicles to wirelessly charge with some flexibility for malalignment over the charging pad; and to charge while in motion to some degree. The technology uses a source resonator and a device (receiver) resonator: “Witricity power sources and receiver devices are specially designed magnetic resonators that efficiently transfer power over large distances via the magnetic near-field.”

In a wireless charging technology developed by researchers at Cornell University, a “Semi-Toroidal Interleaved-Foil Coupled [Capacitive] Inductors uses a “13.56 MHz 12-cm air-gap [prototype] capacitive WPT system, to transfer 2.25 KW at an efficiency of 90%, achieving 29.6 KW/m² power transfer density.” In several car brands explored, the ground clearance is typically 14 cm to 22 cm. As such, more energy will be required by a Semi-Toroidal Inductor technology to achieve the same power density transfer coefficient, or a radical redesign of vehicles will need to take place to lower the ground clearance to 12 cm or less, to achieve maximum efficiency power transfer. Either solutions will result in exorbitant cost and or extensive research in design and engineering, to implement new low ground clearance vehicles.

To date, a reliable and cost-effective approach to charge electric vehicles while in motion, particularly at highway at speeds of over 60 mph, has not been commercially realized due to a number of factors related to cost or practical implementation of coupled inductive, coupled resonant technologies or capacitive inductors, as described. As such an unconventional approach not relying on static power transfer technologies may offer a more reliable and cost-effective means to charge EVs (Electric Vehicles) while in motion.

The electric motor and generator inventions, credited to Michael Faraday, remain the cornerstone for mechanical force conversion to electricity and vice versa, to power nearly all modern appliances such as vacuum cleaners, blenders, refrigerators and light bulbs. Over the last decade, the use of electric motors began to make its way into the automobile industry, whereby many major manufacturers have all pledged or have begun the development of pure electric vehicles, running on electric motors and batteries only.

It is common knowledge that electricity has been used in the automobile industry in a secondary manner for nearly a century. Applications such as starting of the combustion engine with electricity, powering radios in cars, to permit driving at night with headlights, were all adaptations that served the auto industry well. However it is only in the last two decades that electric cars have begun to rely exclusively on electricity for locomotion which may eventually phase out internal combustion vehicles, in the same way early petrol fueled cars have replaced horse drawn coaches and carriages.

Within the last decade we have seen the rise of many major automobile manufacturers, developing ‘electric cars’, using Michael Faraday's electric motors in more sophisticated and energy efficient manner. In the United States for example, automotive manufacturer like Tesla® has taken over the midsize luxury market for all automobiles with the introduction of its Model 3 midsize car. The forecast for a total EV takeover, displacing internal combustion engine vehicles, looks inevitable, and is being strongly supported with worldwide climate change initiatives.

As the world and automakers transition to electric vehicles, the range of travel for an electric car is its only limitation, which for the time being is addressed by privately owned charging ports dotting the landscape, which require upward of one hour to recharge an EV to full capacity of a range of 300 to 345 miles.

With the lack of equal amounts of electric charging stations, as compared to gasoline or diesel infrastructures, other solutions are employed to mitigate the prolonged charging time. Home charging in one's garage and charging at work, in a parking lot, are all practical solutions for an everyday local commute. However, when driving long distances, spanning thousands of miles, other options comparable to fueled (internal combustion engines) vehicles are required. The ability to recharge to 100% capacity in under fifteen minutes remains elusive. Companies such as Quantumscape® have reportedly achieved 80% battery charging capacity within this timeframe, which undoubtedly will be affected by environmental conditions, and in particular, temperature.

A novel solution of battery swapping (Baas)—battery as a Service™, is being pioneered by a company in Asia. This ingenious solution only requires a reported 3-7 minutes to replace a deplete battery with a fully charge battery of at least 100 kwh. The only drawback with this technology is the weight of the battery which will limit its range on par with a gasoline vehicle to around 400 miles. The weight factor of batteries equals more energy consumption and less range, though the solution of battery swapping offers far more advantages than a stationary port charging station. Nonetheless, all vehicles carrying a large battery for long range benefit is carrying “dead weight” of approximately 25%-35% of the vehicle's overall mass.

Evidently by removing the more than one ton battery out of most EVs and charging the vehicle on the go will be the “holy grail” benchmark to be achieved. As noted before, several companies are indeed pursing this wireless charging option which would reduce the mass of vehicles and extend their range infinitely, in a similar way that electric buses and trains have been operating with overhanging power lines providing electricity for their locomotion. Overhead powerline is not practical for EV or electric trucks; however wireless charging from devices imbedded in highways will offer the best possible wireless charging modality.

Despite many of the drawbacks associated with early adaptation of electric vehicles, great strides have been made in the electric car industry, whereby thousands of privately owned charging stations are now available across most developed countries, and many companies are partnering with residential buildings, hotels, public parking spaces and garages to install even more charging stations, fairly rapidly. With the advent of a highway charging network, the cost of an EV can be lowered, since the raw materials for battery manufacturing, such as cobalt, is becoming harder and more costly to acquire. As noted above, the battery component is roughly one third the total cost of the vehicle in most cases.

### SUMMARY OF THE DISCLOSURE

It is an objective of the present invention to introduce a novel technology that is able to charge a vehicle while it is in motion, thereby accelerating the time to get from point A to B in the shortest possible time.

In is another objective to bring down the overall cost of an EV, which can be priced near or above 100% higher than a vehicle of similar size that uses gasoline fuel. This is achieved by reducing the battery weight, cost and size by 50% or more.

A stationary subterranean solenoid, acting upon a mechanical inducted generator may offer greater advantages over all the before mentioned approaches. In one embodiment, the apparatus within the EV can operate in a manner similar to an internal combustion engine, when influenced by an external electromagnetic force. With the aid of gravity, kinetic energy and momentum the piston apparatus will continue to generate electricity for a finite period of time, without being influenced by an external magnetic flux.

The present Highway Integrated Solenoid Charging System (HISCS) is a next generation charging system which utilizes a road imbedded electromagnetic array, which can be activated upon demand, using electromagnetic sensors or automatic switches (when a vehicle is present) to affect the magnetic flux within the road, to power a generator or linear solenoid situated onboard a vehicle.

The forgoing invention utilizes a linear solenoid arranged vertically in an EV, to continuously generate electricity when influenced by gravity, external magnetic flux and one or more springs attached to the permanent magnet situated within the linear solenoid embodiment. In another embodiment, circumferential magnetic “paddles” are engaged with the electromagnets within the roadway to provide mechanical force, to operate a generator onboard an EV.

The disclosed embodiments provide a mean to wirelessly charge a vehicle when in motion or at rest. Unlike conventional wireless charging systems as outlined that have no moving parts, the technology herein uses electromagnetic means to influence linear solenoids or electromagnets to provide mechanical force to act upon a generator to produce electricity. Though the technology is preferably constructed using electromagnets, permanent magnets may be used within a roadway, having suitable magnetic flux to cause rotation of a generator's shaft or undulation of a linear solenoid. Unlike resonant or inductive wireless charging which have no moving parts, the technology herein has a generator onboard the vehicle which produces electricity when placed in the field of the electromagnet.

Roads can be retrofitted with said permanent or electromagnets at spaced intervals with minimal retrofitting. The cost to retrofit roads and highway with electromagnets will be a fraction of the cost compared to resonant or inductive systems. Moreover, all car manufacturers can design and build their own generators or solenoid systems for their vehicles in order to make use of a roadway equipped with electromagnets or permanent magnets to act upon the vehicle's electricity generator or solenoid.

### BRIEF DESCRIPTION OF THE DRAWING

FIG. 1 is a side cross sectional view of electromagnets imbedded in roadway and automobile on the road way.

FIG. 2 is a frontal cross sectional view of FIG. 1.

FIG. 3 is a frontal view of the wireless charging apparatus with the vehicle component removed.

FIG. 4 is a perspective view of a multilane highway with a designated lane for EV charging.

FIG. 5 is a frontal cross sectional view of an alternate embodiment of the wireless charging system.

FIG. 6 is side view of FIG. 5 depicting an array of subterranean electromagnets and solenoid within a vehicle.

### DETAILED DESCRIPTION

The technology uses a novel mechanical approach to generate electricity within a vehicle when influenced by electromagnets imbedded in a roadway or parking location. In one embodiment, a solenoid generator is set into motion by the external electromagnets, and is further influenced by gravity and the kinetic energy stored within a spring. In another embodiment, a series of magnets are arranged circumferentially to rotate in one direction when affected by the flux of an electromagnet situated in the roadway. In either case, the electricity generated can be used to power electrical systems of the vehicle. If the EV uses regenerative braking, the generated electricity, when the vehicle must slow for a stop, or the vehicle is traveling down a hill, may also be used to assist in recharging energy into the drive battery, thus increasing the efficiency of the vehicle.

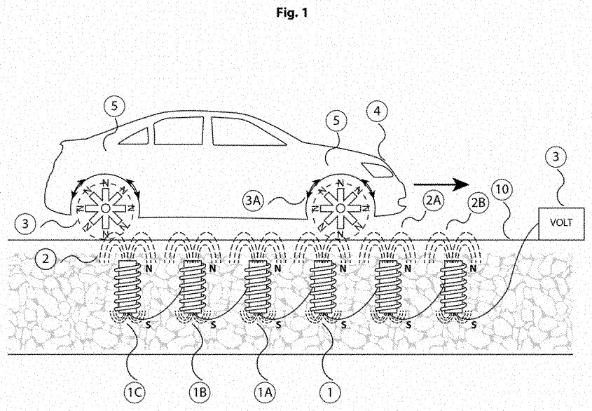

With reference to FIG. 1, a cross sectional view of a roadway 10 and an automobile 4 is situated on said roadway, 10. Within the roadway are electromagnets spaced at equal intervals to allow for the continuous rotation of the generator's shaft at a desirable resolution when subjected to the magnetic forces action on the circumferentially arranged magnets, 3 and 3A.

The automobile of FIG. 1 is equipped with a generator, which generates electricity as the “magnetic wheels” 3 and 3A are rotated about an axis, when influenced by the electromagnetic forces 2 and 2A from magnets in the road. In a stationary parked position of the vehicle, at least one solenoid may be used to propel the generator, connected to the magnetics, 3 and 3A, via a shaft, to rotate in a clockwise or anti-clockwise direction to generate electricity. The rate of revolution is dependent on the force of the electromagnet flux, air gap between the two components etc. As noted before, a permanent magnet may be used to drive the generator when in motion or parked.

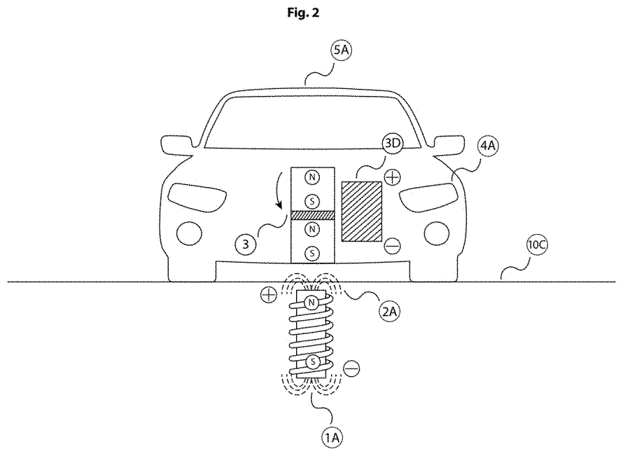

A frontal view of the system is shown in FIG. 2. A conventional generator 3D is situated on the floor level of a vehicle with a shaft 3, having an array of magnets arranged circumferentially thereabout. The magnets all have the same polarities at distal end, and the opposite polarities at the proximal end, with the shaft. As such North poles will all cause rotation in one direction when they are subjected to the magnetic field of the electromagnets which are imbedded within the road. The rotation result in the production of electricity as the vehicle passes over the series of solenoids or electromagnets positioned at desirable increments along a highway, for hundreds or thousands of miles.

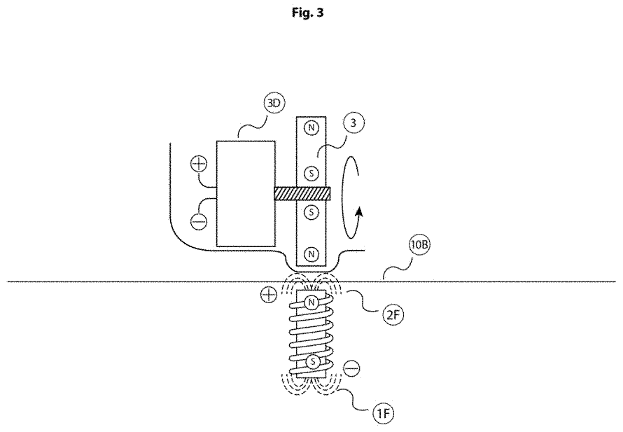

FIG. 3 is an isolated view of the generator and solenoid components of FIG. 2. The generator's shaft is fixed with a magnetic “paddle wheel”3 that rotates in one direction when subjected to the magnetic force of at least one electromagnet. The electromagnets are preferably powered by solar panels situation along the highway or some other form of renewable energy. The electromagnets are ideally actuated upon demand, based on the presence and speed of the vehicle passing over them. The vehicle may possess an electromagnetic sensing probe or the electromagnets may have sensors to detect the presence of an approaching vehicle so as to power on or off upon demand. The sensor may detect the rate of change of a previous electromagnetic flux disruption, caused by a passing vehicle; therefore the timing of the next electromagnet can be in the on position at the appropriate time and then the off position after the passing vehicle clears the location.

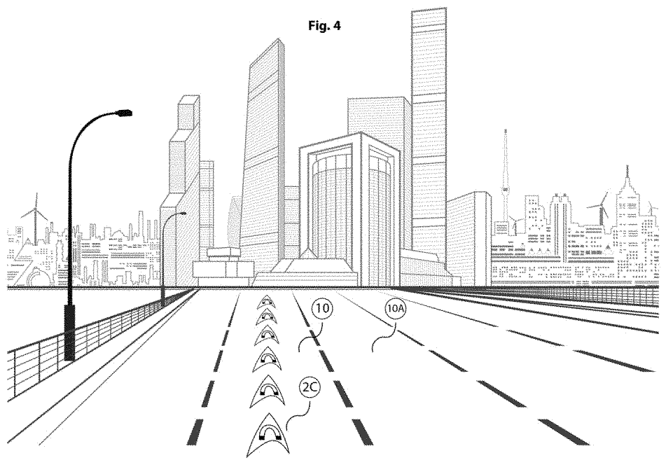

FIG. 4. Illustrates an aerial view of a multi-lane highway 10A, with one lane 10 marked for vehicles (trucks, cars, buses etc.) equipped to use electromagnetic force for propulsion by induction. Any number of lanes may be equipped with electromagnets to provide continuous wireless propulsion for the recharging of vehicles when in motion.

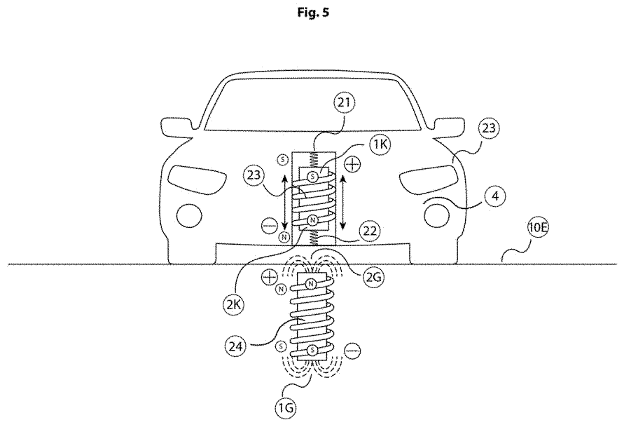

FIG. 5 is an alternate embodiment of a linear solenoid system situated within a vehicle's front compartment 4, comprising of a permanent magnet with north and south poles, 2k and 1k, and induction coil 23; and buffering springs 21 and 22 which regulates the jarring movement of the permanent magnet, resulting from the effects of gravity and magnetic flux, and to store its kinetic energy in an alternating fashion.

In both embodiments as described a vehicle is able to generate electricity when influenced by the electromagnets imbedded in a roadway. The technology does not require any precise coupling as is the case with other wireless charging system or high level of energy to induce a current within the vehicle. For efficiency, a computer may regulate and sense the use of each electromagnet or group of electromagnets, to power on when being used, and off when not in use. The flux of the electromagnets can also be regulated as a function of the current, density of the coil and other factor such as chosen metal alloys, height of one pole with respect to the air gap of the vehicle's clearance etc., in a manner well known by those skilled in the art and anticipated within the design and implementation of this system. A stationary charging system is also anticipated by using any of the two embodiments or a combination of both. Permanent magnets may also replace or complement the subterranean electromagnets which are imbedded in a roadway.

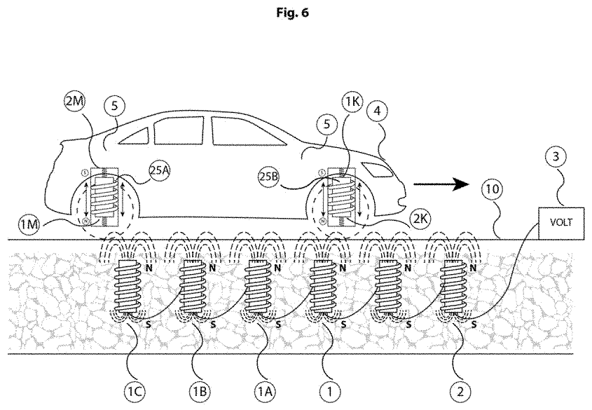

FIG. 6 is a side view of FIG. 5, depicting the solenoid embodiments 25A and 25B situated towards the front and rear of the vehicle. The solenoids are influenced by the electromagnets 1 and 1A.

I claim:

1. A vehicle recharging system using as least one electromagnet situated in a subterranean manner, in a roadway, for interacting with a generator in a vehicle, the generator having permanent magnet paddle wheels situated circumferentially about its shaft, wherein the shaft undergoes rotation to produce electricity.

2. A system of claim 1, where the generator is positioned and connected within the vehicle to provide current to a battery in a continuous manner.

3. The system of claim 2 regulated by a computer and powered by solar panels or an electric grid.

4. The system of claim 1 regulated by a computer and powered by solar panels or an electric grid

5. A vehicle recharging system using as least one electromagnet situated in a subterranean manner in a roadway, for interacting with a linear solenoid apparatus within a vehicle to produce electricity.

6. The system of claim 5 regulated by a computer and powered by solar panels or an electric grid.

7. The system of claim 6 having a sensor to turn off the electromagnets when not in use, and turn on the electromagnets when in use or anticipated use, when a vehicle is present.

8. The system of claim 7 regulated by a computer and powered by solar panels or an electric grid.
